(19) United States
(12) Patent Application Publication
(10) Pub. No.: US 2014/0176329 A1
(43) Pub. Date: Jun. 26, 2014

(54) SYSTEM FOR EMERGENCY RESCUE

(71) Applicant: Seongbin KIM, Seoul (KR)

(72) Inventor: Seongbin KIM, Seoul (KR)

(21) Appl. No.: 14/098,757

(22) Filed: Dec. 6, 2013

(30) Foreign Application Priority Data
Dec. 26, 2012 (KR) 10-2012-0152783

(51) Int. Cl. G08B 21/02

(52) U.S. Cl. CPC G08B 21/02
USPC 340/539.13; 340/539.11

(57) ABSTRACT

Disclosed is an emergency rescue system that senses the changes in motion and the physical condition of the user according to this invention once it is activated. If there are differences compared to the information that had been stored previously in regards to motion and physical state of the user, secret emergency signal generator creates a secret signal for emergency and sends it out. Transmission terminal sends out the information regarding the surrounding environment and the secret emergency signal that it received from secret emergency signal generator by automatically running the emergency rescue program that had been previously stored. Management server creates a rescue signal to be sent out with the information on the surrounding environment when it receives the secret emergency signal.

### TECHNICAL FIELD

Present invention pertains to emergency rescue system; to be more specific, it is about the emergency rescue system that can rescue the user by generating a secret emergency signal.

### BACKGROUND ART

Current mobile communication system has strengthened multimedia function and supports function that takes picture with the camera within the mobile terminal and other functions such as receiving and sending pictures or videos. This is made possible by MMS (multimedia messaging service) server to send and receive multimedia data wirelessly.

Recently, there is an emergency key function in the mobile communication terminal that comes handy when users encounter dangerous situations through multimedia function.

This mobile communication terminal that provides protection function of the prior art only functions when the user in danger presses the emergency rescue key in the mobile terminal; thus, it cannot work when the user does not have the mobile terminal at hand.

Moreover, since the user has to press the emergency key in the mobile terminal, the criminal could easily spot that the user is calling out for help which could lead to a more dangerous situation.

Moreover, when the rescue request and mobile communication terminal's GPS (Global Positioning System) position information is sent, there is a limit in pinpointing the exact location of the user as the information is limited to showing the area where user is located.

### SUMMARY OF INVENTION

### Technical Problem

Accordingly, the present invention has been made in view of the above-mentioned problems occurring in the prior art, and it is an object of the present invention to provide generate secret emergency signal by measuring the user's physical state or changes in the motion wherein the user can call out for help and request to be rescued without having to press emergency rescue key. Moreover, it is another object of this present invention to provide emergency rescue system that can provide exact location of the user by sending out the information regarding the surrounding environment of the transmission terminal.

### Solution to Problem

To accomplish the above object, emergency rescue system according to this present invention is composed of secret emergency signal generator that measures the physical state or sense the difference in user's motion and generates a secret emergency signal when there are differences in motion and physical state when compared to the information that had been previously saved; transmission terminal that sends out the information regarding the surrounding environment and the secret emergency signal that it received from secret emergency signal generator; management server that creates rescue signal to be sent out with the information on the surrounding environment when it receives the secret emergency signal from the transmission terminal; and more than one rescue signal receiver that receives rescue signal and the information regarding the environment from the management server to display them.

Secret emergency signal generator includes the sensor that detects change in the movement or one that measures the user's physical state; first storage area that stores the standard information; first control sector that compares the standard information to the changes in motion or physical state; secret emergency signal generator that generates secret emergency signal when there are differences between the standard information that have been saved and the changes in motion or physical state as the result of comparison from the first control sector; first communication module that sends the secret emergency signal to management server or transmission terminal; and it includes secret emergency signal requestor that requests for secret emergency signal to the secret emergency signal sector according to the present invention.

Emergency rescue system according to the present invention includes more than one factors such as blood pressure, blood pulse or brainwave and the change in user's motion, it is that the user shakes the secret emergency signal generator.

Emergency rescue system according to the present invention includes standard information which has the information on average blood pressure, average blood pulse and brainwave or more than one factor that will shake the secret emergency signal generator.

Secret emergency signal generator includes secret emergency signal request sector which generates secret emergency signal when user provides the input according to the present invention.

Secret emergency signal generator and transmission terminal which are part of emergency rescue system according to the present invention are connected by unique identification number.

Secret emergency signal generator which is a part of emergency rescue system according to the present invention includes first display system that shows if it is possible to communicate with the transmission terminal.

Secret emergency signal generator which is a part of emergency rescue system can be easily carried according to the present invention.

First communication module which is a part of emergency system uses more than one method to communicate with transmission terminal by making use of Bluetooth module, short distance wireless communication or mirror cast according to the present invention.

First signal is generated by secret emergency signal sector, second signal is generated when there are differences between standard information and the changes in motion and third signal is generated when there are differences between the first sector and physical state as well as standard information as according to the present invention regarding the emergency rescue system.

Transmission terminal which is a part of emergency system includes second communication module, second storage and second control sector; when the second communication module receives the secret emergency signal, it operates the emergency rescue system which had been saved in the second storage area to collect the information regarding the environment of transmission terminal; second storage area stores the information regarding the environment of transmission terminal, wherein the second communication module sends the secret emergency signal and the information regarding the environment of transmission terminal to the management server according to the present invention.

Information regarding the surrounding environment pertains to telephone number that had been connected to transmission terminal, GPS location related information of transmission terminal, information of the transmission terminal, visual information from the surrounding area of the transmission terminal, audio information from the surrounding area of the transmission terminal, temperature of the area that transmission terminal is in, and more than a single information regarding the humidity and wind speed according to the present invention.

Audio information that had been mentioned above is the sounds from surrounding area recorded by the recorder located within the transmission terminal or recorder connected to transmission terminal; visual information is the video from the surrounding area recorded by the camera located within the transmission terminal or camera connected to transmission terminal which is part of the emergency rescue system according to the present invention.

Management server mentioned above includes third communication module, third storage area and third control sector wherein when the third communication module receives the secret emergency signal and the information regarding the surrounding environment from the transmission terminal, third storage area saves the information regarding the surrounding environment from the transmission terminal, third control sector searches if whether the secret emergency signal is first, second or the third, generates the rescue request signal, third communication module sends the rescue request signal to more than one of the pre-registered rescue request receivers according to the signal that had been searched as part of the emergency rescue system according to the present invention.

Rescue request signal is in a form of SMS (Short Message Service), push alarm or an App message as part of the emergency rescue system according to the present invention.

Management server sends the information regarding the surrounding environment of the transmission terminal to the rescue signal receiver in case a request comes through from the rescue signal receiver as part of the emergency rescue system according to the present invention.

Management server sends the information regarding the surrounding environment of the transmission terminal to the rescue signal receiver in case a request comes through from the rescue signal receiver as part of the emergency rescue system according to the present invention.

Management server regularly sends the rescue request message and information regarding the surrounding environment of the transmission terminal as part of the emergency rescue system according to the present invention.

More than one rescue signal receivers include fourth communication module that receives rescue request signal and the information regarding the surrounding environment of the transmission terminal; second display unit that displays rescue request signal and information regarding the surrounding environment of the transmission terminal; and request sector that can request the information regarding the surrounding environment of the transmission terminal to the management server according to the present invention.

### Advantageous Effects of Invention

According to the present invention, it is possible to rescue the user in a quick manner when the user is in a potentially dangerous situation.

As it enables the user to call out for rescue by measuring the user's physical state, the user can call out for help even when he or she is unconscious or rendered helpless.

### BRIEF DESCRIPTION OF THE DRAWINGS

FIG. 1 is an illustration depicting emergency rescue system according to the present invention.

FIG. 2 is an illustration depicting secret emergency signal generator emergency rescue system according to the present invention.

FIG. 3 is an illustration depicting transmission terminal emergency rescue system according to the present invention.

FIG. 4 is an illustration depicting management server emergency rescue system according to the present invention.

FIG. 5 is an illustration depicting rescue signal receiver emergency rescue system according to the present invention.

### DETAILED DESCRIPTION OF EXEMPLARY EMBODIMENTS

In order to describe the manner in which the above-recited and other advantages and features of the disclosure can be obtained, more particular description of the principles briefly described above will be rendered by reference to specific embodiments thereof which are illustrated in the appended drawings.

Understanding that these drawings depict only exemplary embodiments of the disclosure and are not therefore to be considered to be limiting of its scope, the principles herein are described and explained with additional specificity and detail through the use of the accompanying drawings in which are as follows.

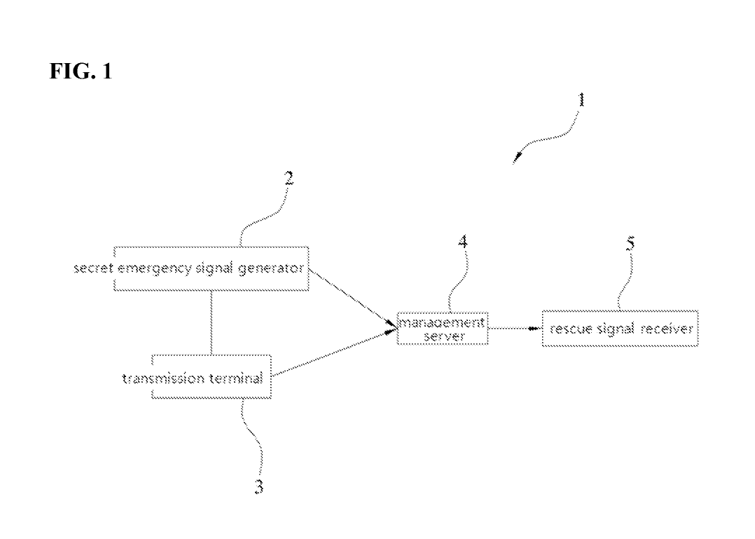

FIG. 1 is an illustration depicting emergency rescue system according to the present invention.

According to the present invention, emergency rescue system 1 includes secret emergency signal generator 2, transmission terminal 3, management server 4 as well as rescue signal receiver 5.

Emergency signal generator 2 senses changes of the motion and measures the physical state of the user. For instance, user's physical state refers to blood pressure, pulse and brain wave and changes in motion refers to the user shaking the secret emergency signal generator 2.

Emergency signal generator 2 generates secret emergency signal by comparing the user's physical state and changes in motion with the standard information that had been stored previously.

Transmission terminal 3 automatically launches the emergency rescue program that had been stored previously when it receives the secret emergency signal that secret emergency signal generator 2 sent over.

When emergency rescue program is activated, transmission terminal 3 sends the information regarding the surrounding environment of the transmission terminal 3 to the management server 4.

When the management server 4 receives the secret emergency signal from the transmission terminal 3, it sends more than one rescue request signal to the rescue signal receiver 5.

Rescue request signal may be in a form of SMS (Short Message Service), push alarm or an App message SMS (Short Message Service), push alarm or an App message that may include the message that the user is in trouble.

Rescue signal receiver 5 receives the information regarding the surrounding environment and the rescue signal that management server 4 sends out. Rescue signal receiver 5 can display the rescue signal and the information regarding the surrounding environment. Therefore, it is possible to rescue the user as it makes known if whether the user is in a dangerous situation.

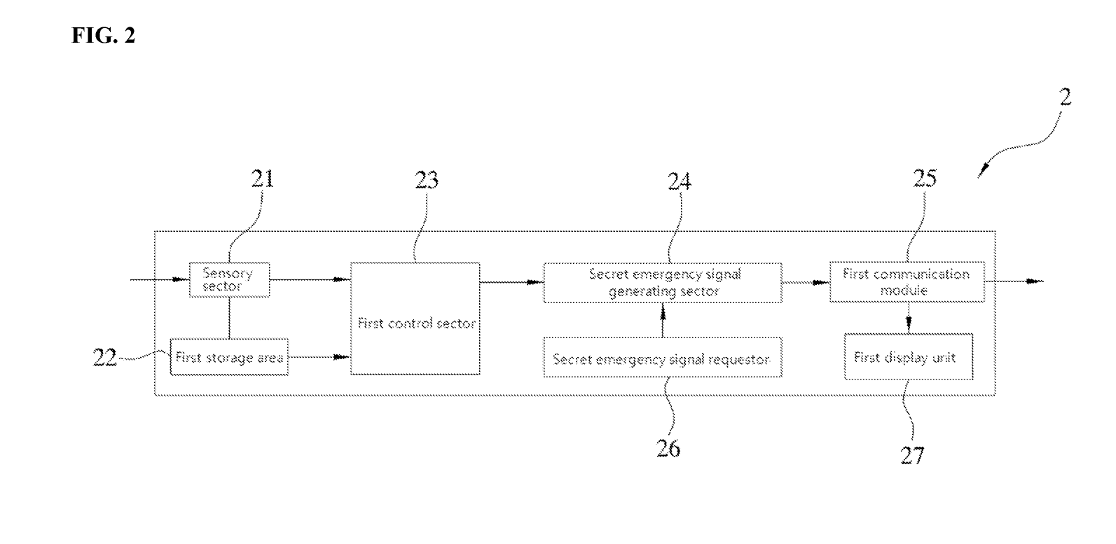

FIG. 2 is an illustration depicting secret emergency signal generator which is a part of emergency rescue system according to the present invention.

According to FIG. 2, secret emergency signal generator 2 includes sensory sector 21, first storage area 22, and first control sector 23, secret emergency signal generating sector 24, first communication module 25 and first display unit 27.

Sensory sector 21 senses changes in user's motion and measures the physical state of the user. There are various sensors in the sensory sector 21.

First storage area 22 saves the standard information beforehand. Standard information refers to average blood pressure, average blood pulse and brainwave and that secret emergency signal generator 2 shakes certain number of times.

First control sector 23 compares the previously stored information in the first storage area 22 and the changes in motion and physical state of the user that sensory sector 21 had perceived.

Secret emergency signal generating sector 24 generates an emergency secret signal in accordance with the control of first control sector 23.

To be more specific, first control sector 23 commands the secret emergency signal generating sector 24 to generate secret emergency signal when there are differences compared to the information that had been stored previously in regards to motion and physical state of the user.

For instance, when the user is in dangerous situation, blood pressure, pulse and brain wave may change. Therefore, user's blood pressure, pulse and brain wave is measured and compared to the user's average blood pressure, pulse and brain wave. When there are differences in results after comparison, secret emergency signal generator 1 creates a secret emergency signal.

First communication module 25 sends the secret emergency signal to the transmission terminal 3 or the management server 4.

First communication module 25 can make use of Bluetooth module, short distance wireless communication or mirror cast but it is not limited to these modules.

Moreover, secret emergency signal generator 2 may include secret emergency signal requestor 26. User may make the secret emergency signal generating sector 24 generate secret emergency signal through the secret emergency signal requestor 26.

Secret emergency signal requestor 26 could be a button. Therefore when the user clicks on the button, secret emergency signal generating sector may generate a secret emergency signal.

Secret emergency signal can be distinguished into first signal, second signal, and third signal. The first signal is generated when the user clicks the secret emergency signal request sector; second signal is generated when there are differences between standard information and changes in motion in the first sector 23, and the third signal is generated when there are differences between the first sector 23 and physical state as well as standard information.

Secret emergency signal generator and transmission terminal are connected by each of their unique identification number and the first display unit can display if it is possible to communicate. First display unit 27 displays the current status ready for communicate to the user.

Moreover, according to the present invention, secret emergency signal generator 2 can be easily carried by the user. For instance, accessories like earrings, rings, bracelets, necklace and watches may be included but not limited to these as long as it is portable.

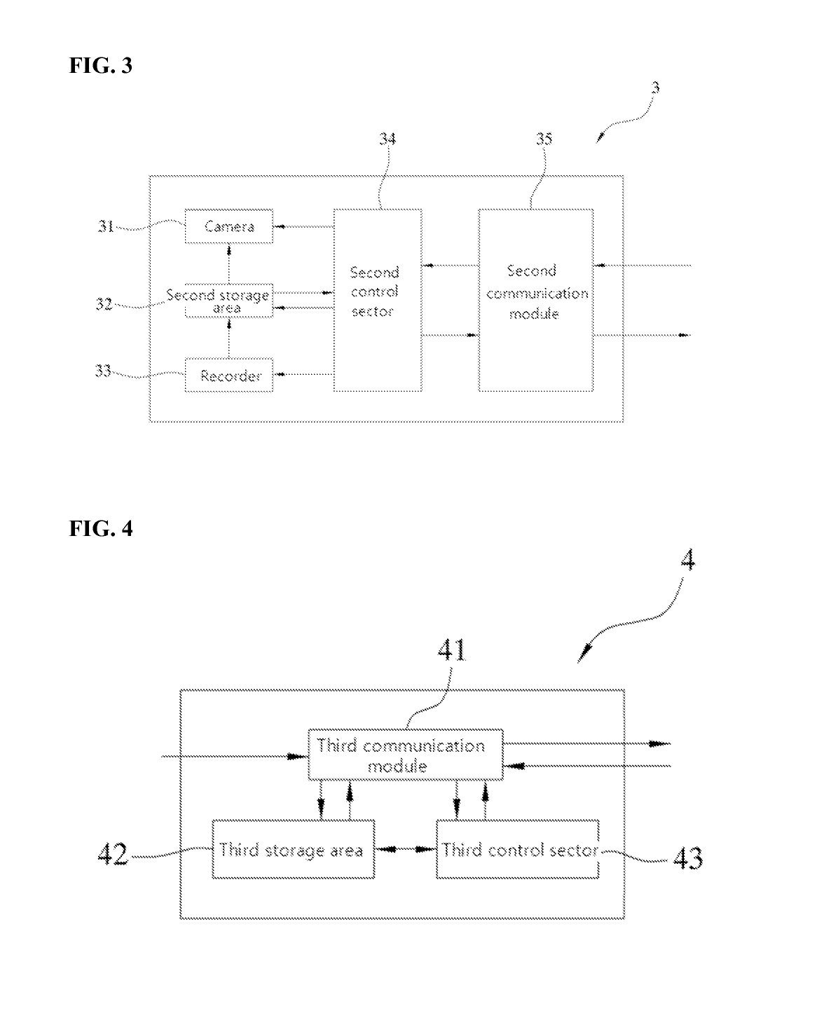

FIG. 3 is an illustration depicting transmission terminal of the emergency rescue system according to the present invention.

According to FIG. 3, transmission terminal 3 according to the present invention includes second storage area 32, second control unit 34, and second communication module 35.

Second communication module 35 receives the secret emergency signal that first communication module 25 had generated from the secret emergency signal generator 2 can make use of Bluetooth module, short distance wireless communication or mirror cast but it is not limited to these modules.

Second storage area 32 stores the emergency rescue program.

When the second control unit 34 sends the secret emergency signal, control unit 34 activates the emergency program that had been stored in the second storage area 32.

Emergency rescue program collects the information regarding the surrounding area of the transmission terminal 3. Moreover, information regarding the surrounding area that had been collected will be stored in the second storage area 32.

GPS location related information of transmission terminal 3, information of the transmission terminal 3, visual information from the surrounding area of the transmission terminal 3, audio information from the surrounding area of the transmission terminal 3, temperature of the area that transmission terminal 3 is in, and information regarding humidity and wind speed

Transmission terminal 3 may include the camera 31 that can take pictures of the surrounding environment of the transmission terminal 3 and the recorder 33 that can record the sounds of the surrounding environment. Camera 31 and the recorder 33 can be activated simultaneously when the emergency rescue program is activated.

Audio information refers to the sounds from surrounding area recorded by the recorder located within the transmission terminal 3 or recorder connected to transmission terminal 3. Recorder and the transmission terminal 3 can communicate as they are connected to each other.

Visual information is the video from the surrounding area recorded by the camera 31 within the transmission terminal 3 or the camera 31 connected to the transmission terminal 3. Camera and the transmission terminal 3 can communicate as they are connected to each other.

Camera that had been connected to the transmission terminal 3 means that the communication method had been connected.

As the result, it is possible to collect the audio and visual information from the surrounding area of the transmission terminal 3 when the emergency rescue program of the transmission terminal 3 is activated when the secret emergency signal is received by the transmission terminal 3 through second communication module 35.

Second communication module 35 sends the information regarding the surrounding environment of the transmission terminal 3 and the secret emergency signal to the management server 4.

Smart phone can be used as a transmission terminal 3; however, it is not limited to smart phone only.

According to the present invention, FIG. 4 is an illustration depicting management server of the emergency rescue system according to the present invention.

In reference to FIG. 4, management server 4 may include third communication module 41, third storage area 43 and third control sector 44.

Management server 4 collects the information regarding the surrounding environment of the transmission terminal 3 and the secret emergency signal through third communication module 41.

Third control sector 44 generates the rescue request signal when it receives secret emergency signal through the third communication module 41 after searching if the secret emergency signal belongs to the first, second or third signal. When it is categorized to first or second signal, rescue request message can be transmitted to pre-registered rescue signal receiver 5 that security company uses.

When it is categorized to third signal, rescue request message can be transmitted to pre-registered rescue signal receiver 5 that security company uses and the pre-registered rescue signal receiver 5 that medical organization uses.

This signifies that rescue signal receiver 5 may differ with the classification of the secret emergency signal.

Management server 4 can transmit the rescue requesting message and information regarding the surrounding environment of the transmission terminal 3 and the rescue request signal to one or more rescue signal receiver 5.

Information regarding the surrounding environment of the transmission terminal 3 and the rescue request signal is transmitted to rescue signal receiver 5 through the third communication module 41.

Moreover, management server 4 can transmit the information regarding surrounding environment of the transmission terminal 3 to the rescue signal receiver 5 when it receives a request from the rescue signal receiver 5.

Moreover, management server 4 can transmit the information regarding surrounding environment of the transmission terminal 3 and the rescue request signal to the rescue signal receiver 5 regularly. Therefore, it is possible to let them know that the user is in a dangerous situation.

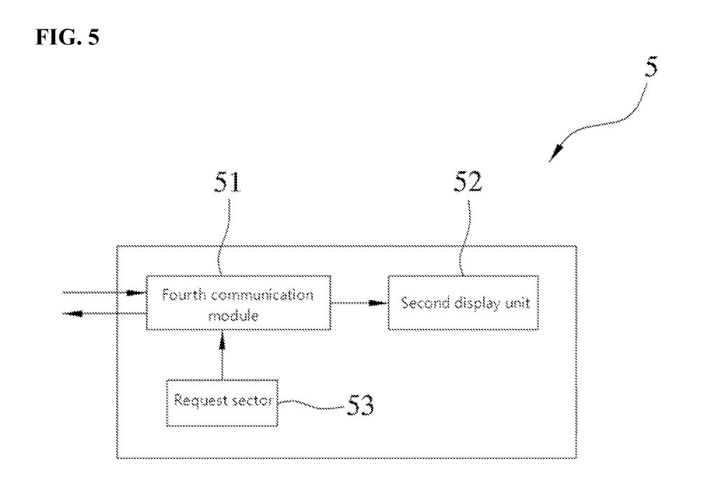

FIG. 5 is an illustration depicting rescue signal receiver of the emergency rescue system according to the present invention.

Rescue signal receiver 5 may include fourth communication module 51, second display unit 52 and request sector 53.

Fourth communication module 51 receives the information regarding the surrounding environment of the transmission terminal 3 rescue request signal and the rescue request message that management server 4 transmitted.

Information regarding the surrounding environment of the transmission terminal 3 rescue request signal and the rescue request message through the second display unit 52.

Display equipments such as LCD, PDP and LED may be used as second display unit 52 but other equipments that may be used as visual medium may be used as well.

It is possible to repeatedly request the information regarding the surrounding environment of the transmission terminal 3 through the request sector 53 to the management server 4. This is due to the fact that information regarding the surrounding environment of the transmission terminal 3 may change in real time. For example, when the transmission terminal 3 moves outside from indoors, change may occur as the speed of the movement had increased.

Various embodiments of the disclosure are discussed in detail as above. While specific implementations are discussed, it should be understood that this is done for illustration purposes only. A person skilled in the relevant art will recognize that other components and configurations may be used without parting from the spirit and scope of the disclosure.

### EXPLANATION OF THE SIGNS

1: Emergency rescue system 2: Secret emergency signal generator
21: Sensory sector 22: First storage area
23: First control sector 24: Secret emergency signal generating sector
25: First communication module 26: Secret emergency signal request sector
27: First display unit 3: transmission terminal
31: Camera 32: Second storage area
33: Recorder 34: Second storage area
35: Second communication module 4: Management server
41: Third communication module 42: Third storage area
51: Fourth communication module 52: Second display unit
53: Request sector

What is claimed is:

1. wherein secret emergency signal generator that measures the physical state or sense the difference in user's motion and generates a secret emergency signal when there are differences in motion and physical state when compared to the information that had been previously saved;
transmission terminal that sends out the information regarding the surrounding environment and the secret emergency signal that it received from secret emergency signal generator;
management server that creates rescue signal to be sent out with the information on the surrounding environment when it receives the secret emergency signal from the transmission terminal; and
more than one rescue signal receiver that receives rescue signal and the information regarding the environment from the management server to display them;
secret emergency signal generator includes the sensor that detects change in the movement or one that measures the user's physical state; first storage area that stores the standard information; first control sector that compares the standard information to the changes in motion or physical state; secret emergency signal generator that generates secret emergency signal when there are differences between the standard information that have been saved and the changes in motion or physical state as the result of comparison from the first control sector; first communication module that sends the secret emergency signal to management server or transmission terminal; and it includes secret emergency signal requestor that requests for secret emergency signal to the secret emergency signal sector;
secret emergency signal is classified into first signal, second signal and third signal;
first signal is generated by secret emergency signal sector, second signal is generated when there are differences between standard information and the changes in motion and third signal is generated when there are differences between the first sector and physical state as well as standard information as according to the present invention regarding the emergency rescue system.

2. wherein in regards to claim 1, emergency rescue system according to the present invention includes more than one factors such as blood pressure, blood pulse or brainwave and the change in user's motion, it is that the user shakes the secret emergency signal generator.

3. wherein in regards to claim 1, emergency rescue system according to the present invention includes standard information which has the information on average blood pressure, average blood pulse and brainwave or more than one factors that shake the secret emergency signal generator certain number of times.

4. wherein in regards to claim 1, secret emergency signal generator and transmission terminal which are part of emergency rescue system according to the present invention are connected by unique identification number.

5. wherein in regards to claim 1, secret emergency signal generator which is a part of emergency rescue system according to the present invention includes first display system that shows if it is possible to communicate with the transmission terminal.

6. wherein in regards to claim 1, secret emergency signal generator which is a part of emergency rescue system according to the present invention can be easily carried.

7. wherein in regards to claim 1, first communication module which is a part of emergency system uses more than one method to communicate with transmission terminal by making use of Bluetooth module, short distance wireless communication or mirror cast.

8. wherein in regards to claim 1, transmission terminal which is a part of emergency system includes second communication module, second storage and second control sector; when the second communication module receives the secret emergency signal, it operates the emergency rescue system which had been saved in the second storage area to collect the information regarding the environment of transmission terminal; second storage area stores the information regarding the environment of transmission terminal, wherein the second communication module sends the secret emergency signal and the information regarding the environment of transmission terminal to the management server.

9. wherein in regards to claim 1, information regarding the surrounding environment pertains to telephone number that had been connected to transmission terminal, GPS location related information of transmission terminal, information of the transmission terminal, visual information from the surrounding area of the transmission terminal, audio information from the surrounding area of the transmission terminal, temperature of the area that transmission terminal is in, and more than a single information regarding the humidity and wind speed.

10. wherein in regards to claim 9, audio information that had been mentioned above is the sounds from surrounding area recorded by the recorder located within the transmission terminal or recorder connected to transmission terminal; visual information is the video from the surrounding area recorded by the camera located within the transmission terminal or camera connected to transmission terminal which is part of the emergency rescue system.

11. wherein in regards to claim 1, management server mentioned above includes third communication module, third storage area and third control sector wherein when the third communication module receives the secret emergency signal and the information regarding the surrounding environment from the transmission terminal, third storage area saves the information regarding the surrounding environment from the transmission terminal, third control sector searches if whether the secret emergency signal is first, second or the third, generates the rescue request signal, third communication module sends the rescue request signal to more than one of the pre-registered rescue request receivers according to the signal that had been searched as part of the emergency rescue system.

12. wherein in regards to claim 11, rescue request signal is in a form of SMS (Short Message Service), push alarm or an App message as part of the emergency rescue system.

13. wherein in regards to claim 11, management server sends the information regarding the surrounding environment of the transmission terminal to the rescue signal receiver in case a request comes through from the rescue signal receiver as part of the emergency rescue system.

14. wherein in regards to claim 11, management server regularly sends the rescue request message and information regarding the surrounding environment of the transmission terminal as part of the emergency rescue system.

15. wherein in regards to claim 1, more than one rescue signal receivers include fourth communication module that receives rescue request signal and the information regarding the surrounding environment of the transmission terminal; second display unit that displays rescue request signal and information regarding the surrounding environment of the transmission terminal; and request sector that can request the information regarding the surrounding environment of the transmission terminal to the management server.
